(19) United States
(12) Patent Application Publication
(10) Pub. No.: US 2014/0283445 A1
(43) Pub. Date: Sep. 25, 2014

(54) Apertured Lawn Treatment Spike

(71) Applicant: Phillip Chabot, Rycroft (CA)

(72) Inventor: Phillip Chabot, Rycroft (CA)

(21) Appl. No.: 14/057,241

(22) Filed: Oct. 18, 2013

Related U.S. Application Data
(60) Provisional application No. 61/804,960, filed on Mar. 25, 2013.

(51) Int. Cl. A01G 29/00

(52) U.S. Cl. CPC A01G 29/00
USPC 47/48.5

(57) ABSTRACT

The present invention describes a lawn spike that is configured to distribute a solution of water, fertilizer, or pesticides into the soil. The device includes a proximal end and a spiked distal end, whereby the proximal end includes a reservoir and a removable cap, and the spiked distal end includes an elongated shaft having a plurality of apertures and a distal tip configured for insertion into the soil surface. In use, the device is inserted into the ground with a mallet or similar device and the cap is removed. The reservoir is filled with a solution, which then gravity fed into the spiked distal end for distribution through the apertures of the elongated shaft and into the soil. The present invention distributes pesticides, plant food, or water into the ground, helps to fertilize soil to ensure proper plant growth, and controls the drainage of the solution into the ground.

### CROSS REFERENCE TO RELATED APPLICATION

This application claims the benefit of U.S. Provisional Application No. 61/804,960 filed on Mar. 25, 2013, entitled “Ant Killer/Plant Feeder.” The above identified patent application is herein incorporated by reference in its entirety to provide continuity of disclosure.

### BACKGROUND OF THE INVENTION

1. Field of the Invention

The present invention relates to a lawn treatment applicator. More specifically the invention relates to a lawn spike comprising a perforated leading end, whereby the perforations facilitate the treatment of the lawn.

Plants can serve as a very nice addition to the decor of a home or may function as a food source. Maintaining a home garden containing fruits, vegetables, or aesthetically appealing plants are typically an easy task for those who have the time to provide the necessary nutrients to the garden.

In order to provide a healthy and safe environment for plants in a garden, a user must provide water, fertilizer, and pesticides for protecting the plant against harmful animals or insects. Existing methods for maintaining a garden include direct application of water, pesticides, and nutrients, as well as automatic means such as sprinklers and dispensing tools.

The present invention relates to a new and improved method of delivering nutrients or pesticides to a garden using a ground insertion device. The device includes a perforated spike, a reservoir for containing a solution, and a reservoir cap for securing the contents within the device. The interior of the device can contain and distribute water and fertilizers for feeding plants, and may further distribute an insecticide for the extermination of pests. The solution within the reservoir flows through the perforations on the spike and into the soil surface, thereby applying the solution in a more direct manner to the plants. The reservoir cap may be removably attached to the reservoir by threads. The cap may comprise a small hole to prevent air locking and may comprise a specialized locking mechanism to prevent tampering by children.

2. Description of the Prior Art

Devices have been disclosed in the prior art that relate to plant nutrition delivery devices. These include devices that have been patented and published in patent application publications. These devices generally relate to ground spikes configured for the distribution of nutrients or pesticides to soil. The following is a list of devices deemed most relevant to the present disclosure, which are herein described for the purposes of highlighting and differentiating the unique aspects of the present invention, and further highlighting the drawbacks existing in the prior art.

One such device in the prior art is U.S. Pat. No. 4,089,133 to Duncan, which discloses a device for feeding liquids to potted plants. The device includes an elongated tubular reservoir having an open end having a cap thereon. The device further comprises a frusto-conical end which facilitates the distribution of the nutrients within the device into the soil for use by the potted plants. However, while the device of Duncan includes an end adapted for distributing nutrients to the plants, it differs from that of the present invention in that it fails to provide a device that comprises a plurality of perforations thereon, for distributing nutrients into the soil.

Another patent, U.S. Pat. No. 3,821,863 to Chan, teaches a controlled fertilizer feeder, which includes a tapered container that is adapted to push into the ground. A top compartment of the container comprises a source of fertilizer and a bottom compartment contains additional plant nutrients. Moreover, the top and bottom compartment serve as a source of air to supply oxygen to the soil. Although the device of Chan is similar in nature and relevant to the present invention, it differs in that it fails to provide a continuous internal reservoir, which facilitates the distribution of nutrients to the soil through a plurality of apertures.

Another such patent, U.S. Pat. No. 4,776,130 to West describes a plant fertilizer holder, which includes a spike and a handle, whereby the handle is above ground and has a decorative design. The spike includes a shaft portion that allows a commercial plant food spike to be placed therein, and to be replaced when the food within the spike is used up. The handle may be decorated in the form of a human or other intended design molds. However, while the patent of West provides nutrients below the ground, the device fails to provide a plurality of apertures configured for the distribution of nutrients to plants.

Yet another patent, U.S. Pat. No. 3,914,900 to Bigelow teaches a decomposable or biodegradable plugs that serve as carriers for plant growth-promoting elements such as fertilizer, soil conditioners, insecticides, seeds and repellants. There are several pockets at different points along the plug, whereby the pocket enable the distribution along different depths and positions of the soil. While Bigelow teaches an insert similar to that of the present invention, it fails to provide a portion above the ground that is configured for the reception of nutrients, and further lacks a cap that is configured for closing the device.

Another patent, U.S. Pat. No. 6,370,812 to Burns teaches a system for controlling termites, whereby the system includes a monitoring system that includes two interfacing, separable pieces that can be bound together. The system may comprise a toxicant-containing matrix therein that encourages termites to contact the matrix, wherein the termites are exposed to lethal doses of a slow-acting toxicant. Although the prior art of Burns teaches a pesticide, it fails to further teach a device having a tapered end comprising apertures, which are configured for distributing nutrients to plants.

Finally, U.S. Pat. No. 2,837,861 to Graham teaches an insecticide container, which includes a base member, and concentric inner and outer walls, whereby the walls may contain the insecticide, which may have either a liquid or a paste form. While the exterior of the device comprises a dome that comprises apertures, the device of Graham fails to comprise a tapered end having a plurality of apertures that are configured to distribute nutrients into the soil.

The present invention relates to a pesticide and plant nutrient delivery device that is configured for the treatment of home gardens. The device includes a proximal end having an opening therein, a reservoir connected to the proximal end, and a spiked distal end comprising a plurality of apertures. After insertion into the soil, the interior of the reservoir is capable of retaining water, fertilizer, or pesticides for the extermination of pests. The solution contained within the reservoir is guided downward within the device and flows out of the apertures and into the soil, thereby administering the nutrients to the plants. After the filling of the device, a removable reservoir cap is threadably attached onto the proximal end of the device, thus sealing the solution within. The cap may comprise a small hole to facilitate airflow to permit diffusion. The cap may further comprise a specialized locking mechanism that prevents tampering from children by requiring a wrench or similar tool to remove the reservoir cap.

It is submitted that the present invention is substantially divergent in design elements from the prior art and consequently it is clear that there is a need in the art for an improvement to existing lawn spike devices. In this regard the instant invention substantially fulfills these needs.

### SUMMARY OF THE INVENTION

In view of the foregoing disadvantages inherent in the known types of lawn spikes now present in the prior art, the present invention provides a new device wherein the same can be utilized for providing convenience for the user when a device that comprises mechanisms that deliver nutrients directly to the soil of a plant is desired.

It is therefore an object of the present invention to provide a new and improved lawn spike device that has all of the advantages of the prior art and none of the disadvantages.

It is another object of the present invention to provide a lawn spike device, whereby the device includes a plurality of apertures at a spiked distal end that are configured for delivering treatment to plants.

Another object of the present invention is to provide a device that includes a threaded cap, whereby the cap includes a small opening configured to prevent air locking, and a specialized top configured to reduce tampering.

Yet another object of the present invention is to provide a lawn spike distal end comprising a plurality of apertures.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a view of the lawn spike of the present invention.

FIG. 1B shows an overhead view of the interior of the reservoir of the device.

FIG. 2 shows the distal end of the device, whereby the end comprises a plurality of apertures.

FIG. 3 shows a perspective view of the connection between the cap and the proximal end.

FIG. 4 shows a view of the filling of the reservoir with a treatment solution.

FIG. 5 shows the lawn spike device of the present invention in use.

### DETAILED DESCRIPTION OF THE INVENTION

Reference is made herein to the attached drawings. Like reference numerals are used throughout the drawings to depict like or similar elements of the lawn spike. For the purposes of presenting a brief and clear description of the present invention, the preferred embodiment will be discussed as used for the treatment of plants. The figures are intended for representative purposes only and should not be considered to be limiting in any respect.

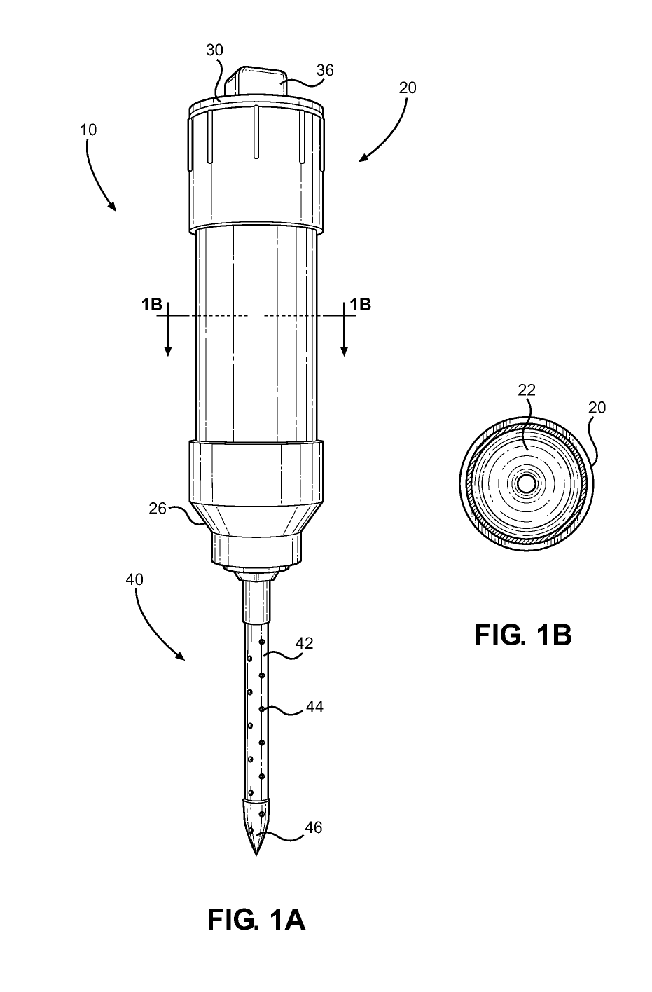

Referring now to FIGS. 1A and 1B, there are shown views of the lawn treatment device of the present invention, whereby FIG. 1A illustrates a side view and FIG. 1B displays an overhead view of the lawn treatment device interior. The lawn treatment device resembles a traditional lawn spike that is configured for delivering a treatment solution to plants. The solution adapted to be dispensed by the present invention may be one or more of water, fertilizer, or pesticides. In use, the spike distal end 40 is inserted into the ground, thereafter a reservoir 20 of the spike is filled with a solution that drips into the soil.

In reference to FIG. 1A, the lawn spike 10 includes a reservoir proximal end 20, which is configured for containing a solution, and a ground spike distal end 40, which is configured for insertion into the ground for administering therapeutic treatment to the soil and plants. The proximal end 20 is a reservoir that is adapted for containing a solution therein and includes a tapered lower end 26 and a reservoir cap 30 upper end for filling purposes. The distal spike end 40 of the device comprises an elongated shaft 42 having a plurality of apertures 44 thereon that communicate fluid from the shaft 42 and from the reservoir 20 thereabove. The pointed tip 46 of the shaft 42 is configured to facilitate insertion into the ground.

Referring now to FIG. 1B, there is displayed an overhead cross-sectional view of the lawn spike device of the present invention, whereby the view illustrates the interior of the reservoir 20. The interior of the reservoir 20 contains a hollow interior 22 that is configured for retaining a solution therein. The solution may be one of water, a fertilizer, or a pesticide for the extermination insects, wherein the reservoir interior 22 contains the solution and slowly drains the same through the spiked distal end 40 and into the ground to be treated. The quantity of solution draining from the reservoir 20 is dependent on the moisture content of the ground within which the spiked distal end 40 is inserted.

Referring now to FIG. 2, there is displayed a view of the spiked distal end 40 of the device 10, whereby the spiked distal end comprises a hollow interior that is connected to the tapered portion of the proximal end of the device. The spiked distal end 40 includes an elongated shaft 42, a plurality of apertures 44, and a pointed distal tip 46. A plurality of apertures 44 is located along the length of the circumference of the shaft 42, whereby their positioning facilitates an even distribution of nutrients into the soil. The pointed tip 46 of the elongated shaft 42 may also include apertures 44, thereby providing an efficient methods of inserting the device into the ground surface and delivering nutrients or pesticides directly into the proximity of the garden plants.

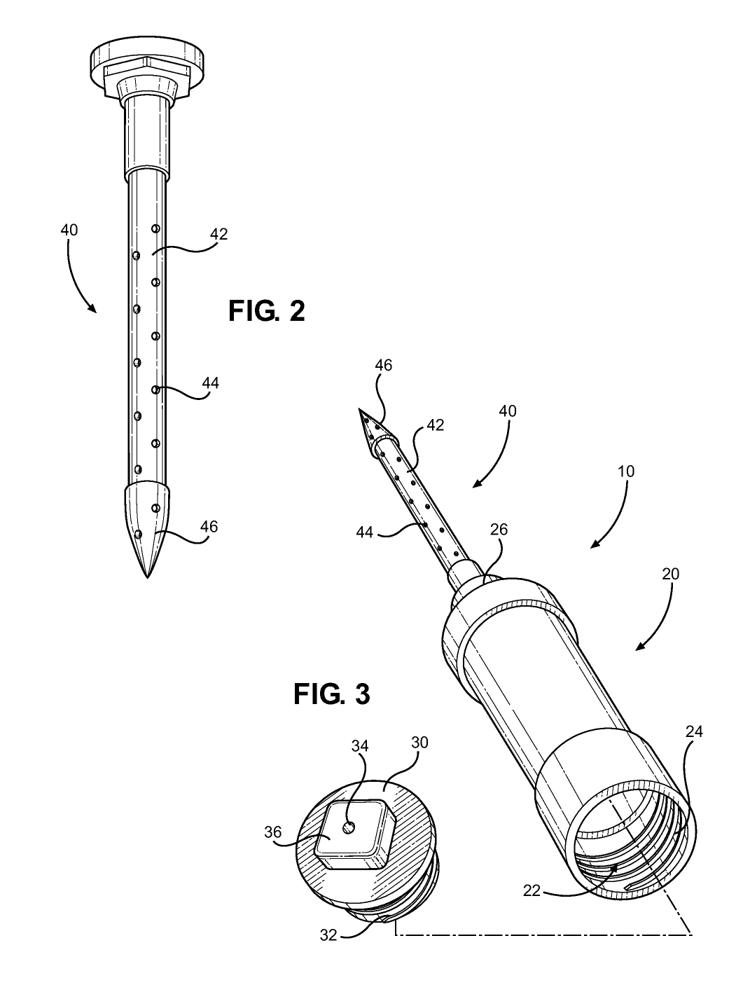

Referring now to FIG. 3, there is shown a perspective view of the connection between the reservoir cap 30 and the reservoir proximal end 20 of the device 10. The reservoir 20 includes an internal volume 22 a tapered portion 26, and a cap 30 configured for closing the reservoir 20. The reservoir 20 entrance comprises a threaded opening 24 that is configured for mating with a reservoir cap 30, whereby the cap 30 includes threads 32 that mate with the threads 24 of the reservoir 20. The cap 30, further includes a square-shaped member 36 including a hole 34 in the center thereof. The square-shaped member 36 is configured to reduce and discourage tampering by others, such as children. This is accomplished by having a member 36 comprise a shape that requires the assistance of a tool, such as a wrench, to open the cap 30. The square-shaped member comprises a hole 34 that facilitates a metered inflow of air into the reservoir interior 22. The hole 34 is located in the center of the surface of the reservoir cap 30, thereby preventing the clogging of the solution within the reservoir 22, and encourages the flowing of solution therefrom.

The spiked distal end 40 is attached to the reservoir proximal end 20, wherein solution from the reservoir communicates into the shaft 42 thereof and through the apertures to the soil. The spiked distal end 40 comprises an elongated shaft 42 having a plurality of apertures 44 and a spiked distal end 46. In use, the solid wall of the reservoir 20, contains the solution within the reservoir interior 22. The tapered end 26 of the reservoir drains the contained solution into the spiked distal end 40, whereby the elongated shaft 42 is configured to distribute the fluid therefrom into the soil.

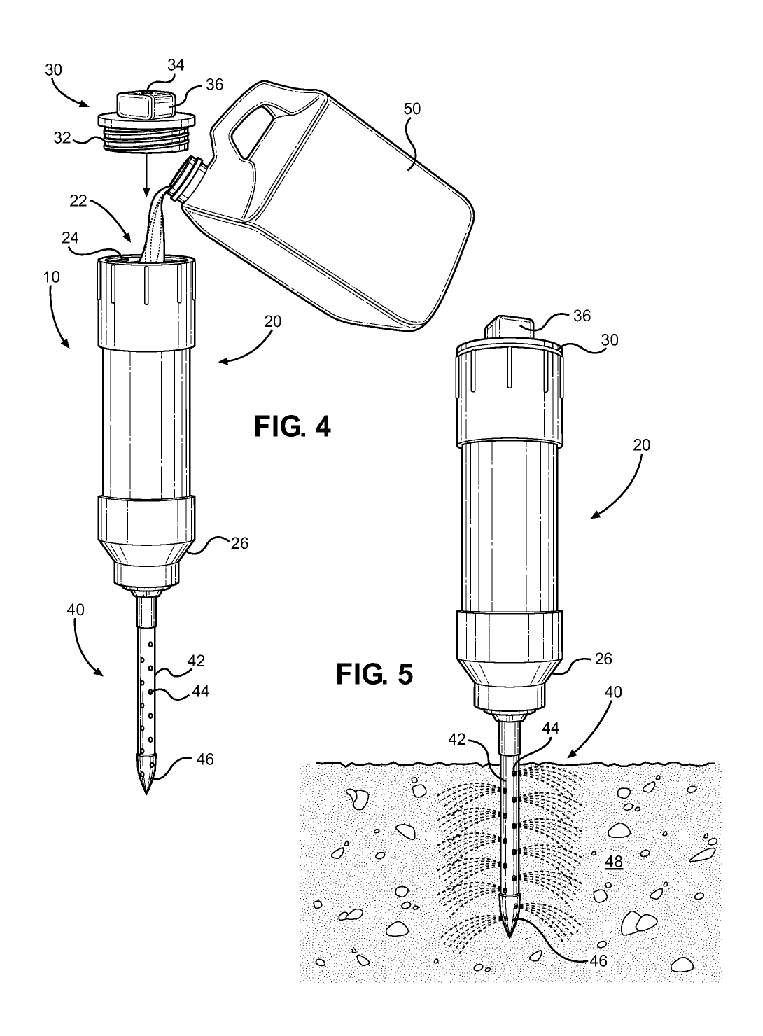

Referring now to FIG. 4, there is a view of the lawn spike device 10 in use, whereby the reservoir 20 is being filed with a solution from a container of fertilizer 50. In the preferred embodiment, the solution may be one of water, fertilizer, and pesticides, whereby the solution is configured for providing treatment to plants. To fill the treatment device 10 with a therapeutic solution, the reservoir cap 30 is removed by gripping the square-shaped member 36 and turning the cap 30 in a manner that separates the cap threads 32 from the reservoir threads 24.

The solution within the reservoir 20 is configured to flow through the tapered end 26 thereof and into the spiked distal end 40, whereby the spiked distal end 40 includes an elongated shaft 42, a plurality of apertures 44 and a pointed distal end 46. The reservoir cap 30 includes a hole 34 that prevents a vacuum from forming within the reservoir as the solution drains therefrom, facilitating the flow of fluid through the apertures 44 of the spiked distal end 40.

Referring now to FIG. 5, there is a view of the lawn spike of the present invention in use, whereby the device 10 is inserted into garden soil surface for the therapeutic treatment of plants. The device 10 includes an upper reservoir proximal end 20 and a lower spiked distal end 40. The device is inserted into the ground prior to being filled with a container 50 having a solution therein. The elongated shaft 42 of the spiked distal end 40 comprises a diameter that facilitates the insertion of the end into the soil, while the tapered end 26 of the reservoir 20 is of a larger diameter, which reduces the likelihood that the proximal end 20 is insertable into the soil in an efficient manner. Having the spiked distal end 40 inserted into the soil prior to the filling of the reservoir 22 is recommended because the filling of the device before insertion into the soil would enable the fluid to exit the apertures 44 of the spiked distal end 40 prior to insertion into the soil.

Next, the reservoir cap 30 is removed and the reservoir 20 is filled in a manner similar to that of FIG. 4. Thereafter the cap 30 is reattached to the threads 24 of the reservoir 20 after the same 20 is filled. The solution within the reservoir 20 is then gravitationally led downward past the tapered end 26 and into the elongate shaft 42 of the spiked distal end 40. The elongate shaft 42 comprises a plurality of apertures 44 throughout the shaft 42. Gravity and the shape of the device 10 facilitate the distribution of solution out of the apertures 44 of the shaft 42, thereby providing a therapeutic treatment to the plants and soil 48.

The present invention relates to a new and improved lawn spike that is configured for the therapeutic delivery of nutrients or pesticides to plants. The device 10 includes an upper reservoir proximal end 20 and a lower spiked distal end 40. The reservoir 20 includes an open interior 22 having a threaded upper 24 and a tapered lower end 26 leading to the spiked distal end 40. The proximal end further includes a reservoir cap 30 comprising threads, an aeration hole 34, and a square-shaped member 36. The square-shaped member 36 is configured for facilitating the removal of the cap from the proximal end 20 to enable the filling of the device 10. The spiked distal end 40 includes an elongated shaft 42 having perforations thereon, and a pointed distal end 46, which is configured for insertion into the soil surface 48.

In use, the device 10 is inserted into the ground with a mallet or other means, and the reservoir cap 30 is removed. A container 50 having a solution then pours the solution into the reservoir interior 22. The flow of solution out of the spiked distal end 40 is facilitated by gravity and the air hole 34 of the reservoir cap 30, which prevents the stoppage of flow though the apertures 44 until the solutions has completely flowed into the soil surface 48. After the solution has completely transferred into the ground, the cap 30 may be removed once more, and a therapeutic solution may once again be supplied to the reservoir 20 to enable continued treatment.

It is contemplated that the apertures 44 of the spiked distal end 40 can be constructed in a variety of sizes to control the flow of liquid therethrough. Smaller aperture holes 44 may permit slower drainage of the solution and larger holes may facilitate faster drainage into the soil, thus an easy and convenient way to prevent insect infestations and to feed plants and trees.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A ground spike configured for delivering nutrients or pesticides to plants directly into the ground, comprising:
a reservoir proximal end comprising a reservoir interior, an upper reservoir cap, and a tapered lower end;
a spiked distal end extending from said tapered lower end comprising an elongated shaft, a plurality of apertures along said elongated shaft, said elongated shaft having a pointed tip;
whereby said spiked distal end is adapted to be entered into a ground surface and said proximal end is configured to remain above a ground surface;
whereby said reservoir is adapted to be filled with a liquid for drain said liquid through said plurality of apertures;
wherein said upper reservoir cap is removable and comprises a hole adapted for communicating air into said reservoir as said reservoir drains.

2. The lawn spike of claim 1, wherein said reservoir of said proximal end is hollow and threadably connects to said reservoir cap.

3. The lawn spike of claim 1, wherein said cap includes a square member, which requires the use of a tool to remove said cap from reservoir.

4. The lawn spike of claim 1, wherein said apertures of said shaft are sized to facilitate a given drainage rate.
